(19) United States
(12) Patent Application Publication
(10) Pub. No.: US 2019/0028330 A1
(43) Pub. Date: Jan. 24, 2019

(54) ELECTRONIC DEVICES WITH AUTOMATED INTELLIGENCE

(71) Applicant: Michael Dalton Wilson, Mallorca (ES)

(72) Inventor: Michael Dalton Wilson, Mallorca (ES)

(21) Appl. No.: 15/578,853

(22) PCT Filed: Feb. 9, 2017
(86) PCT No.: PCT/IB2017/000150

§ 371 Date: Dec. 1, 2017

Related U.S. Application Data
(60) Provisional application No. 62/293,603, filed on Feb. 10, 2016.

(51) Int. Cl. H04L 12/24; H04L 12/26; H04L 12/58

(52) U.S. Cl. CPC H04L 41/0681; H04L 51/24; H04L 43/10; H04L 41/0213

(57) ABSTRACT

Disclosed is a method of controlling an electronic device, the method including defining an event and a variable, monitoring the electronic device for the variable, performing an action when the variable occurs, and sending a notification, the notification including information about the action. In at least one example embodiment, the method may further include monitoring a result of the action, wherein the notification further includes information about the monitored result. Example embodiments also relate to a network switch. In example embodiments, the network switch may be configured to monitor an electronic device for a variable, perform an action when the variable occurs, and send a notification, the notification including information about the action. In addition, the network switch may be configured to receive information about an event and the variable before it monitors the electronic device for the variable.

### CROSS REFERENCE TO RELATED APPLICATION

This application is a 371 of International Application No. PCT/US17/17186 which was filed on Feb. 9, 2017, which claims priority from United States Patent and Trademark Office Provisional Application No. 62/293,603 which was filed on Feb. 10, 2016.

### BACKGROUND

### 1. Field

Example embodiments relate to intelligent devices. A nonlimiting example embodiment of an intelligent device is a network switch having a unique firmware installed thereon. Example embodiments also relate to a method of controlling a network.

### 2. Description of the Prior Art

A network switch, also called a MAC bridge, is a computer networking device that connects several devices together. Network switches are commonly employed in local area networks (LAN) and wide area networks (WAN). Network switches manage the flow of data across a network by enabling point-to-point communication.

### SUMMARY

Network switches often connect to devices which are either prone to failure or susceptible to a data breach. IP cameras and ISP Routers, for example, are known to “lock” or “freeze” for unknown reasons. Databases are susceptible to hacking. The inventor has sought a solution to the above problems which resulted in firmware which, when installed in a network device, results in a new and nonobvious network switch which not only detects problems associated with connected electronic devices, but, in some cases, can actually cure the problems. For example, in one nonlimiting example embodiment, the network switch with the installed firmware may detect that an IP camera is “frozen” and subsequently restart the IP camera to unfreeze it. As another example, the firmware on the network switch may result in a network switch that detects whether a database is being hacked and, in the event the database is being hacked, shut down communication to that database to prevent further hacking. In addition, the network switch with the inventive firmware loaded thereon may also send a message, for example, via email, text messaging, or or network data message, to another network device to an operator who may be interested in knowing whether a device attached to the network switch has failed or whether a database connected to the network switch has been breached.

Disclosed is a method of controlling an electronic device, a nonlimiting example of the method includes defining an event and a variable, monitoring the electronic device for the variable, performing an action when the variable occurs, and sending a notification, the notification including information about the action. In at least one example embodiment, the method may further include monitoring a result of the action, wherein the notification further includes information about the monitored result. Example embodiments also relate to a network switch having firmware thereon to configure and enable the network switch to carry out several operations. In example embodiments, the network switch may be configured to monitor an electronic device for a variable, perform an action when the variable occurs, and send a notification, the notification including information about the action. In addition, the network switch may be configured to receive information about an event and the variable before it monitors the electronic device for the variable.

### BRIEF DESCRIPTION OF THE DRAWINGS

The disclosure will be better understood and when consideration is given to the drawings and the detailed description which follows. Such description makes reference to the annexed drawings wherein:

FIG. 1 is a view of a network switch in accordance with an example of the invention;

FIG. 2 is block diagram of the network switch in accordance with an example of the invention;

FIG. 3 is a view of a method in accordance with an example of the invention;

FIGS. 4A, 4B, and 4C are views of a system, a method, and input variables in accordance with an example embodiment of the invention;

FIGS. 5A, 5B, and 5C are views of a system, a method, and input variables in accordance with an example embodiment of the invention;

FIGS. 6A, 6B, and 6C are views of a system, a method, and input variables in accordance with an example embodiment of the invention;

FIGS. 7A, 7B, and 7C are views of a system, a method, and input variables in accordance with an example embodiment of the invention;

FIGS. 8A, 8B, and 8C are views of a system, a method, and input variables in accordance with an example embodiment of the invention; and

FIGS. 9A, 9B, and 9C are views of a system, a method, and input variables in accordance with an example embodiment of the invention.

### DETAILED DESCRIPTION

Example embodiments will now be described more fully with reference to the accompanying drawings, in which example embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on,” “connected to,” or “coupled to” another element or layer, it can be directly on, connected to, or coupled to the other element or layer or intervening elements or layers that may be present. In contrast, when an element is referred to as being “directly on,” “directly connected to,” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers, and/or sections, these elements, components, regions, layers, and/or sections should not be limited by these terms. These terms are only used to distinguish one element, component, region, layer, and/or section from another elements, component, region, layer, and/or section. Thus, a first element component region, layer or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the structure in use or operation in addition to the orientation depicted in the figures. For example, if the structure in the figures is turned over, elements described as “below” or “beneath” other elements or features would then be oriented “above” the other elements or features. Thus, the exemplary term “below” can encompass both an orientation of above and below. The structure may be otherwise oriented (rotated 90 degrees or at other orientations) and the spatially relative descriptors used herein interpreted accordingly.

Embodiments described herein will refer to plan views and/or cross-sectional views by way of ideal schematic views. Accordingly, the views may be modified depending on manufacturing technologies and/or tolerances. Therefore, example embodiments are not limited to those shown in the views, but include modifications in configurations formed on the basis of manufacturing process. Therefore, regions exemplified in the figures have schematic properties and shapes of regions shown in the figures exemplify specific shapes or regions of elements, and do not limit example embodiments.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments relate to a configurable network switch, which is an example of an electronic device upon which inventive firmware may be loaded so as to enable the electronic device to carry out various operations.

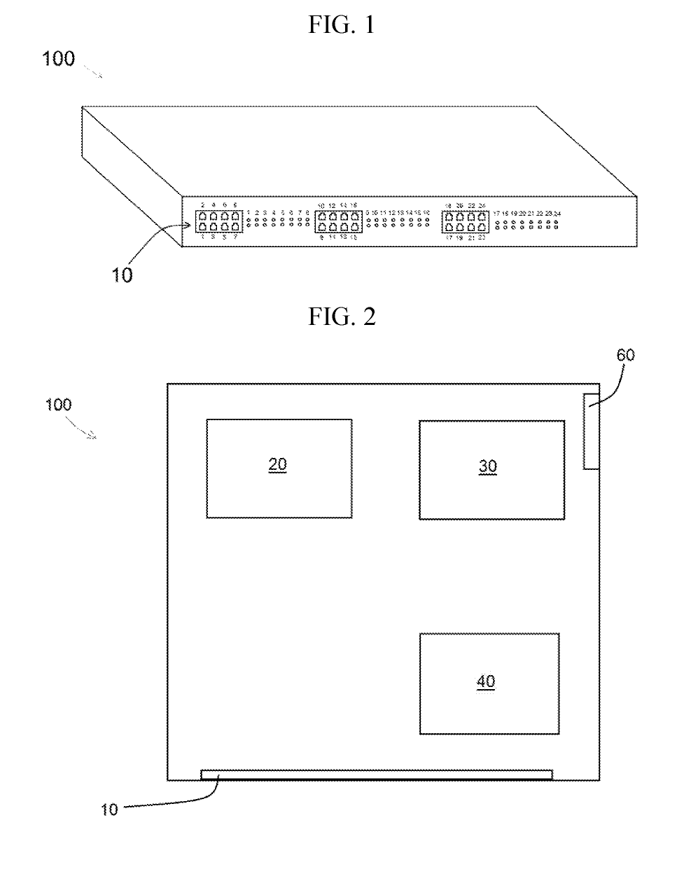

FIG. 1 is a view of a network switch 100 in accordance with example embodiments. As with conventional network switches, the network switch 100 includes a plurality of ports 10. The ports 10 may resemble sockets to which a cable, for example, an Ethernet cable, may attach. The ports 10 may allow data and/or power to flow from the network switch 100 to devices that may be attached to the network switch 100. Nonlimiting examples of devices that may attach to the network switch 100 include printers, computers, telephones, cameras, Wifi access points, and smart power strips. It is understood that while the network switch 100 of FIG. 1 includes twenty four ports 10, the number of ports is not critical to the invention. For example, instead of having twenty four ports 10, the network switch 100 could have less than twenty four ports 10 or more than twenty four ports 10. Further, the ports 10 may be configured to receive another type of cable rather than just an Ethernet cable.

FIG. 2 is a block diagram of the network switch 100. As shown in FIG. 2, the network switch 100 may include a microprocessor 20 configured to carry out various functions. For example, in at least one example embodiment, the microprocessor 20 may execute algorithms stored in a chip 30, for example, a read only memory (ROM) or a randam access memory chip (RAM). In at least one example embodiment, the switch 100 may include a transceiver 40 to allow for wireless communication. In addition (or in the alternative), the switch 100 may include a port 60 which may allow for an over-the-wire connection. The port 60 may, for example, allow for uploading of various computer programs or algorithms into the switch 100. It is understood that while FIG. 2 illustrates only a single microprocessor 20, the microprocessor 20 may represent a plurality of microprocessors 20 which may, or may not, work together to control the network switch 100. In addition, while FIG. 2 shows only a single chip 30, the chip 30 may, in fact, be a plurality of chips which store various types of information and programs usable by the microprocessor 20 to control the network switch 100.

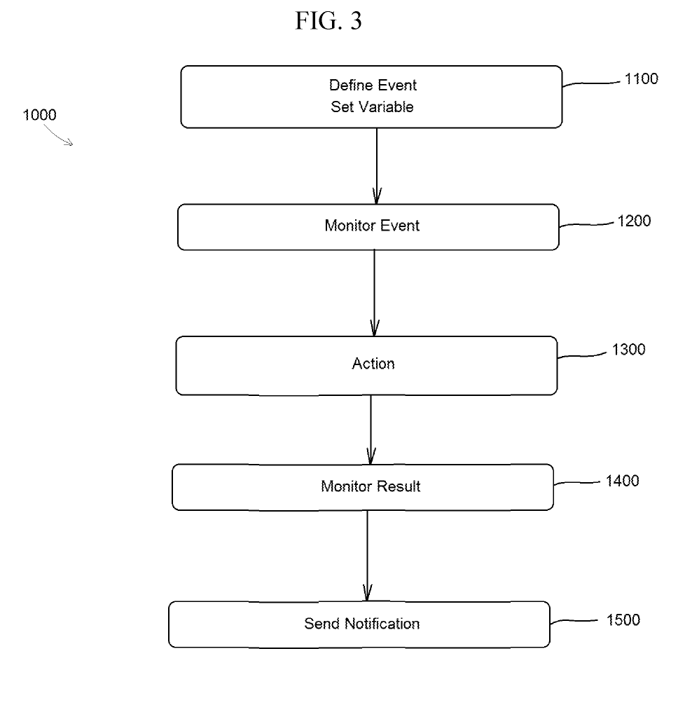

In example embodiments, software (for example, firmware) may be loaded onto the network switch 100 and may enable the network switch 100 to perform various operations. For example, the software may be uploaded to the chip 30 and the microprocessor 20 may use this software to perform the various operations. In at least one example embodiment, the software may cause the network switch 100 to execute a method 1000 (see FIG. 3) which may detect various problems with equipment connected to the network switch 100. In some cases, the software may allow the network switch 100 to cure those problems. The method 1000 also allows for interested parties, for example, network administrators, to learn of the potential problems associated with the equipment connected to the network switch 100 and to determine whether the problem has been fixed or whether maintenance is required.

FIG. 3 is a flowchart illustrating the method 1000. In FIG. 3, the method includes operations of monitoring an event 1200, taking an action 1300, monitoring a result of the action 1400, and sending a notification to a party 1500.

As shown in FIG. 3, the method 1000 may include additional steps of defining an event and setting at least one variable 1100. The operations of defining an event and setting that at least one variable 1100 may be performed by a party, for example, a network administrator. The type of event and the variable may depend on the type of equipment connected to the network switch 100. Nonlimiting examples of the event may be related to a simple network messaging protocol server and client (SNMP), power consumption, dataflow, and/or temperature. The variable may be a parameter which, when detected, triggers the network switch 100 to perform the action 1300. For example, if the event is related to power, the variable maybe a threshold power consumed by an attached device which may trigger the network switch 100 to perform an action, such as power cycling the device.

The Monitor Result operation 1400 is simply an operation which monitors the result of the action taken by the network switch 100. For example, in one nonlimiting example embodiment, the network switch 100 may take the action of powering down a device operating below a threshold value and then powering up the device, the result might be the device's power consumption after it was powered down and subsequently powered up.

The final step of the operation illustrated in FIG. 3, is a notification operation 1500 in which a party is notified of any one of (or all of) the event, the action taken, and the result. The notification may be, for example, an email initiated by the network switch 100 to the recipient. The notification may also include additional information such as, but not limited to, the event defined by a user and/or the variable set by the user.

In example embodiments the software may provide various options for a user (for example, an installer or a network manager) to configure the network switch 100. Configuration of the network switch 100 may be made by user who uses the software loaded on the chip 30. In short, in at least one example embodiment, the software makes options available to a user to configure the network switch 100. In one example embodiment, the options include an ON or OFF feature, EVENT feature, an ACTION feature, a RESULT feature, and a NOTIFICATION feature.

In example embodiments, the ON or OFF feature may set a variable which establishes whether other logic blocks should be evaluated by the network switch 100. If set to “ON” then all parts of EVENT logic must be met before an ACTION is taken. In one nonlimiting example embodiment, the ON or OFF setting is available only when the firmware is loaded onto the network switch 100. In one nonlimiting example embodiment, firmware servers are used to upload the firmware onto the network switch 100 and the firmware server will only do so if the MAC ID of the network switch 100 is in a database used by the firmware server.

The EVENT feature is whatever the installer selected from options contained in the network switch's firmware. The complete EVENT logic must be complete before an Action operation occurs. This option may utilize “and” and “or” options each of which may be contained in the network switch's firmware.

The ACTION feature includes any number of actions available in the network switch's firmware. The action feature may cause either an internal action, with respect to the network switch 100, or an external action, with respect to the network switch 100, or a combination of the two. In some embodiments, the action may be time delayed in either a “start time” or “duration” time.

The RESULT feature is a feature which allows for an original event to be reevaluated to see if a state has changed. This feature may also use “and” and “or” logic conditions.

The NOTIFICATION feature allows an installer to select a type of notification from options contained in the network switch's firmware. The notification, for example, may take on the form an email, a text message, an i-message, or some other form of electronic notification.

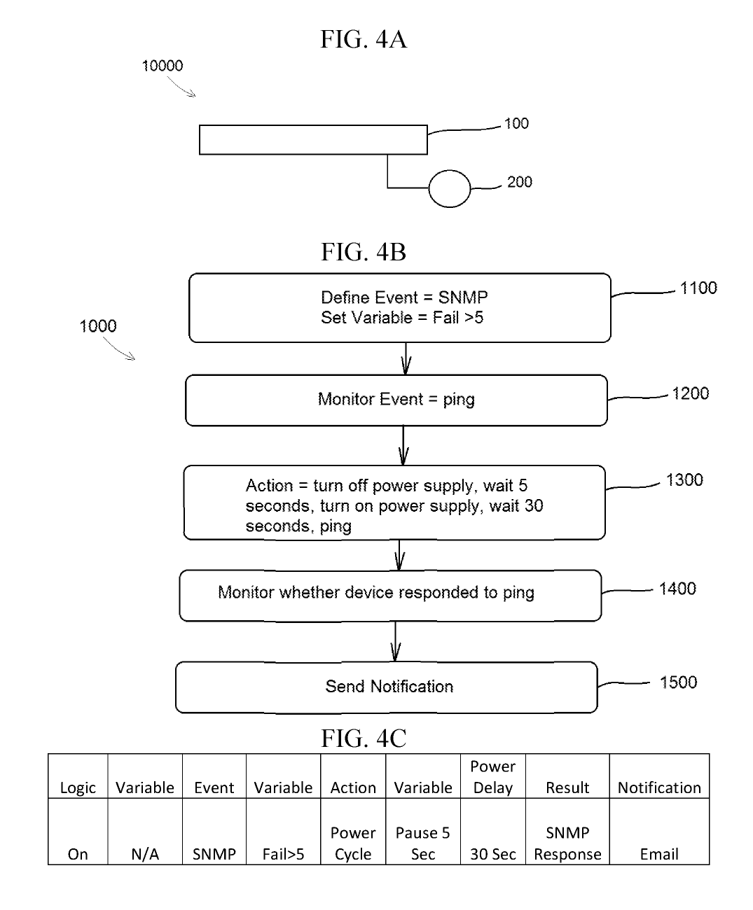

FIG. 4A is a view of a system 10000 using the network switch 100. In FIG. 4A, the system 10000 includes the network switch 100 with an IP CCTV camera 200 connected thereto. It is known that IP CCTV cameras have a problem of “locking up” for no apparent reason. The problems with “locking up” are not trivial as users often don't know a camera has “locked up” until after a need to review recorded footage has arisen. Conventional network switches have no way of dealing with this problem. However, the network switch 100 configured via the inventor's firmware can minimize, if not eliminate, the above problem. For example, a network administrator may configure the network switch 100, via inventor's firmware, to regularly ping the IP CCTV camera 200 and monitor the response of the ping (step 1200). The network administrator may decide that if the IP CCTV camera 200 fails to respond to a predetermined number of pings (for example, five consecutive pings), that the network switch 100 should undertake the action of turning the IP CCTV camera 200 off, waiting five seconds, powering the IP CCTV camera 200 up, waiting for thirty seconds, and pinging the IP CCTV camera 200 again (step 1300). The switch 100 would then monitor whether the IP CCTV camera 200 responded to the latest ping (step 1400) and subsequently send all of this information to the network administrator (step 1500) via email or some other messaging system such as, but not limited to, i-messaging. This method is illustrated in FIG. 4B.

The message sent by the network switch 100 may provide the network administrator with valuable information. For example, if the IP CCTV camera 200, after power cycling, started responding to various pings generated by the network switch 100, the network administrator may conclude the camera 200 is functioning properly, however, if the camera 200 failed to respond to the latest ping, the network administrator may conclude the camera 200 requires maintenance. Furthermore, the software controlling the network switch 100 may correct the problem associated with the IP CCTV camera 200 in the event the power cycling “unlocked” the CCTV camera 200. As such, the duration for which the IP CCTV camera 200 was “locked” may be much shorter than the duration an IP CCTV camera 200 may experience when connected to a conventional network switch since conventional network switches are generally not designed to periodically ping attached IP CCTV cameras and power cycle them in the event they fail to respond to a ping.

FIG. 4C illustrates an example of how a network administrator could use the firmware to set up an automated sequence of commands which may repair a fault (for example, a “locked” IP CCTV camera) and notify the network administrator of the fault and the current state of the network or connected hardware. This may be done on a per port basis and have “and” and “or” logic options. As one skilled in the art would readily understand, FIG. 4C represents an interface having fields which may be populated by a network administrator. For example, the interface may have the following fields, “Logic,” “Variable,” “Event,” “Variable,” “Action,” “Variable,” “Power Delay,” “Result,” and “Notification.”

As was previously explained, when the “Logic” field is assigned an “ON” status the other logic blocks will be evaluated. If the “Logic” field was assigned an “OFF” status, the other blocks would not be evaluated. If the “Logic” field is assigned an “ON” status, then all parts of the “Event” logic must be met before an action is taken. The “Event” field is whatever an installer selects from options contained in the firmware loaded onto the network switch 100. The event logic must be completed before the method may be advanced to the action operation. FIG. 4C shows how a user may define the above variables to enable the method of FIG. 4B to be carried out by the network switch 100.

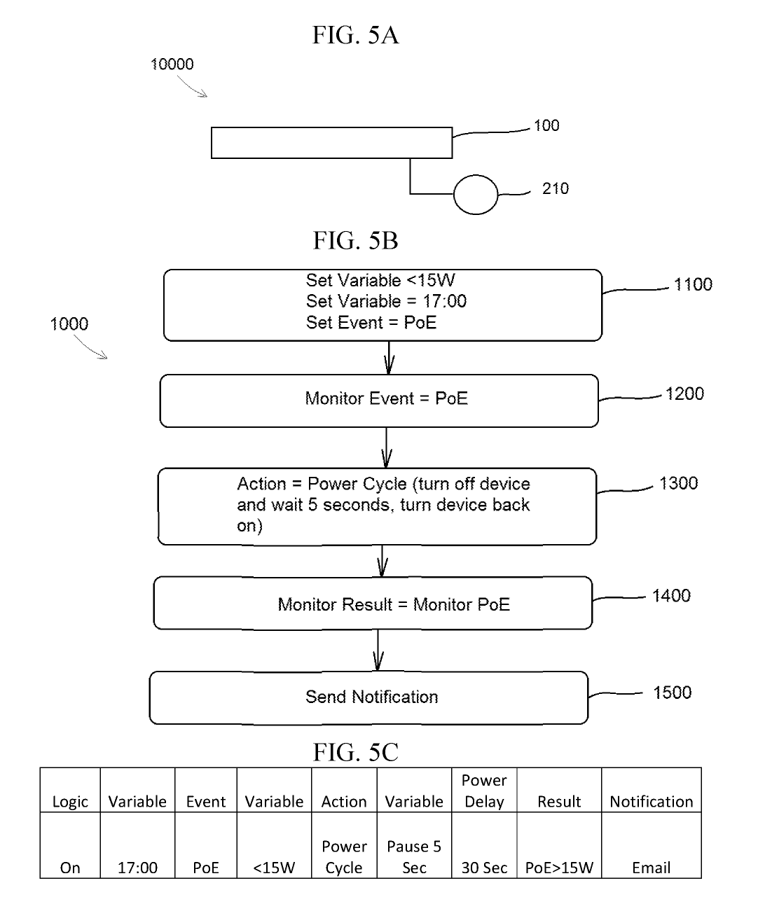

FIG. 5A is a view of a system 10000 using the network switch 100. In FIG. 5A, the system 10000 includes the network switch 100 with a Wifi access point 210. Some Wifi access points 210 require a threshold level of power, for example, 15 W, to properly function. A Wifi access point 210 consuming less than the threshold power, for example, the 15 W, may not be properly working. Conventional network switches are generally not configured to detect whether a Wifi access point 210 is consuming an appropriate amount of power and, if not, performing an action to try and correct the problem. However, the network switch 100 having the inventor's firmware can minimize, if not eliminate, the above problem. For example, a network administrator may configure the network switch 100, via inventor's firmware, to check, at 17:00, whether the attached Wifi access point 210 is consuming less than a predetermined about of power (for example, 15 W). The network administrator may decide that if the Wifi access point 210 is consuming less than the predetermined amount of power, that the network switch 100 should power cycle the device, that is, turn it off, wait five seconds, turn on the device again, wait thirty seconds (step 1300) and then monitor whether the Wifi access point 210 is using 15 W or more (step 1400). The network switch 100 may then send all of this information to the network administrator (step 1500) via email or some other messaging system such as, but not limited to, i-messaging. This method is illustrated in FIG. 5B.

The message sent by the network switch 100 may provide the network administrator with valuable information. For example, if the Wifi access point 210, after power cycling, started using more than 15 W of power the network administrator may conclude the Wifi access point 210 is functioning properly, however, if the Wifi access point 210 continues to use less than 15 W of power the network administrator may conclude the Wifi access point 210 requires maintenance or replacement.

FIG. 5C illustrates an example of how a network administrator could use the firmware to set up an automated sequence of commands which may repair a fault (for example, a “locked” Wifi access point 210) and notify the network administrator of the fault and the current state of the network or connected hardware. As described above, this may be done on a per port basis and have “and” and “or” logic options. As one skilled in the art would readily understand, FIG. 5C represents an interface having fields which may be populated by a network administrator. For example, the interface may have the following fields, “Logic,” “Variable,” “Event,” “Variable,” “Action,” “Variable,” “Power Delay,” “Result,” and “Notification.”

When the “Logic” field is assigned an “ON” status the other logic blocks will be evaluated. If the “Logic” field was assigned an “OFF” status, the other blocks would not be evaluated. If the “Logic” field is assigned an “ON” status, then all parts of the “Event” logic must be met before an action is taken. The “Event” field is whatever an installer selects from options contained in the firmware loaded onto the network switch 100. The complete event logic must complete before the method 1000 may be advanced to the action operation. In at least one example embodiment a network administrator may populate several fields of FIG. 5C to enable the method of FIG. 5B.

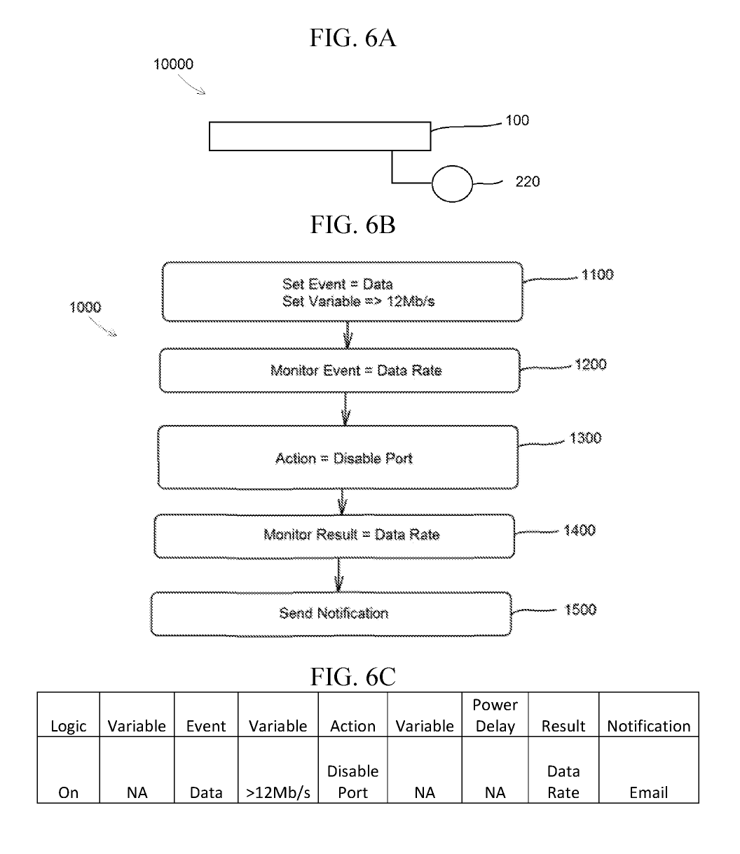

FIG. 6A is a view of a system 10000 using the network switch 100. In FIG. 6A, the system 10000 includes the network switch 100 with a server 220 attached. Servers are often vulnerable to hacking, however, conventional network switches have no way of knowing whether server is being hacked or not. However, the network switch 100 having the inventor's firmware can minimize, if not eliminate, the above problem. For example, a network administrator may configure the network switch 100, via inventor's firmware, to monitor a rate at which data is being sent from the server 220. The network administrator may decide that if rate of data exceeds a predetermined rate (for example, 12 Mb/s) that the network switch 100 should disable the port to which the server 220 is attached to prevent the server from being further hacked. The network switch could then monitor the amount of data that is being sent from the server 220 and then send all of this information to the network administrator (step 1500) via email or some other messaging system such as, but not limited to, i-messaging. This method is illustrated in FIG. 6B.

The message sent by the network switch 100 may provide the network administrator with valuable information. For example, if the data rate leaving the server 220 drops to zero the network administrator may know the server 220 is no longer being hacked but that some proper anti-hacking steps should be taken to properly protect the sever 220. Further, the network administrator would have notice that some data may have been hacked so they could alert the proper personnel.

FIG. 6C illustrates an example of how a network administrator could use the firmware to set up an automated sequence of commands which may prevent hacking and notify the network administrator of any hacking of any connected hardware. As described above, this may be done on a per port basis and have “and” and “or” logic options. As one skilled in the art would readily understand, FIG. 6C represents an interface having fields which may be populated by a network administrator. For example, the interface may have the following fields, “Logic,” “Variable,” “Event,” “Variable,” “Action,” “Variable,” “Power Delay,” “Result,” and “Notification.”

When the “Logic” field is assigned an “ON” status the other logic blocks will be evaluated. If the “Logic” field was assigned an “OFF” status, the other blocks would not be evaluated. If the “Logic” field is assigned an “ON” status, then all parts of the “Event” logic must be met before an action is taken. The “Event” field is whatever an installer selects from options contained in the firmware loaded onto the network switch 100. In this case, the event is related to data and the variable is a data rate which, in this nonlimiting example embodiment, is 12 Mb/s. The complete event logic must complete before the method 1000 may be advanced to the action operation. In at least one example embodiment a network administrator may populate several fields of FIG. 6C to enable the method of FIG. 6B.

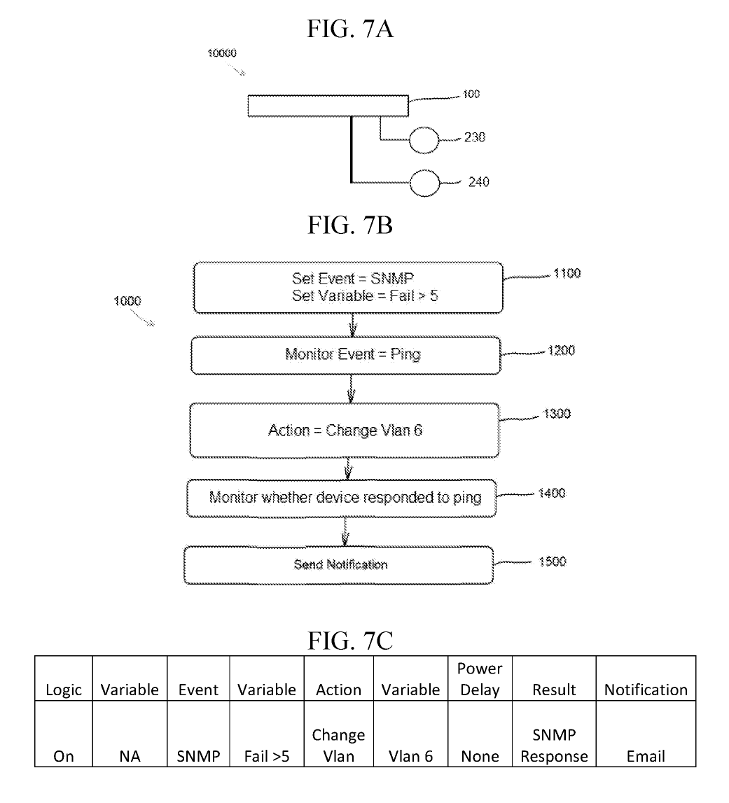

FIG. 7A is a view of a system 10000 using the network switch 100. In FIG. 7A, the system 10000 includes the network switch 100 with a primary server 230 and a backup server 240 attached. In this example, each server 230 and 240 is on a different virtual local area network (VLAN). Servers are prone to failure. In order to minimize the impact of the primary server 230 failing, a network administrator may configure the network switch 100, via inventor's firmware, to monitor the primary server 230, for example, by pinging the primary server 230, and if the primary server 230 fails to respond to a predetermined number of pings (for example, five pings), change the VLAN of the port the primary server 230 is connected to to another VLAN, for example, Vlan 6, which would allow data to be sent to the backup server 240. The network switch 100 would then ping the backup server 240 to ensure the switch was properly made. This method is illustrated in FIG. 7B.

As with the other examples, the message sent by the network switch 100 may provide the network administrator with valuable information. For example, if primary server 230 failed to respond to the five pings from the network switch 100, the network administrator may know there is a problem with the primary server 230. In addition, if the backup server 240 responded to the action (for example, changing the Vlan) taken by the network switch 100 (for example, the ping of step 1400), the network administrator may know the backup server 240 is now functioning as the primary server.

FIG. 7C illustrates an example of how a network administrator could use the firmware to set up an automated sequence of commands which may changes data flow from a primary server to a backup server in the event the primary server is not properly functioning. As described above, this may be done on a per port basis and have “and” and “or” logic options. As one skilled in the art would readily understand, FIG. 7C represents an interface having fields which may be populated by a network administrator. For example, the interface may have the following fields, “Logic,” “Event,” “Variable,” “Action,” “Variable,” “Power Delay,” “Result,” and “Notification.”

When the “Logic” field is assigned an “ON” status the other logic blocks will be evaluated. If the “Logic” field was assigned an “OFF” status, the other blocks would not be evaluated. If the “Logic” field is assigned an “ON” status, then all parts of the “Event” logic must be met before an action is taken. The “Event” field is whatever an installer selects from options contained in the firmware loaded onto the network switch 100. In this case, the event is related to pinging a primary server. The complete event logic must be complete before the method 1000 may be advanced to the action operation. In at least one example embodiment a network administrator may populate several fields of FIG. 7C to enable the method of FIG. 7B.

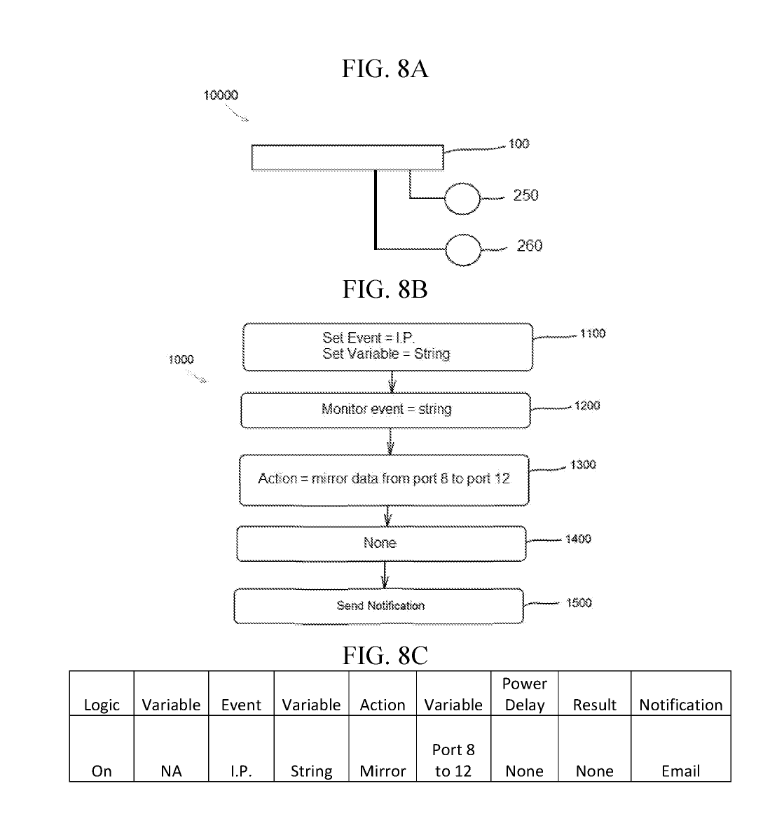

FIG. 8A is a view of a system 10000 using the network switch 100. In FIG. 8A, the system 10000 includes the network switch 100 with two devices attached: a suspect device 250, and a monitoring device 260. The suspect device 250 may be any device in which a defect is suspected. For example, the suspect device may be a server which is suspected of some sort of failure. The monitoring device 260 may be a device operated by a technician. In order to help diagnose whether the suspect device 250 is defective a technician may send an I. P. string to the network switch 100 and the when the I.P. string matches an I.P. string stored in the network switch 100, the network switch 100 may mirror data sent to the suspect device 250. For example, if the suspect device 250 is on port 8 and the monitoring device is on port 12 the network switch 100 may mirror data sent to port 8 to port 12. This method is illustrated in FIG. 8B.

As with the other examples, the message sent by the network switch 100 may provide the network administrator with valuable information. For example, if the device 250 is believed to be defective, a technician may attach a monitoring device 260 to the network switch 100 and send an I.P. string to the network switch 100. The network switch 100 may then respond by mirroring data sent to the port associated with the suspect device to the port associated with the monitoring equipment. A technician may then use this data to determine whether or how much data to determining what data is sent to the suspect device 250 to diagnose potential problems associated with the suspect device 250.

FIG. 8C illustrates an example of how a network administrator could use the firmware to set up an automated sequence of commands which may mirror dataflow to two ports. As described above, this may be done on a per port basis and have “and” and “or” logic options. As one skilled in the art would readily understand, FIG. 8C represents an interface having fields which may be populated by a network administrator. For example, the interface may have the following fields, “Logic,” “Event,” “Variable,” “Action,” “Variable,” “Power Delay,” “Result,” and “Notification.”

When the “Logic” field is assigned an “ON” status the other logic blocks will be evaluated. If the “Logic” field was assigned an “OFF” status, the other blocks would not be evaluated. If the “Logic” field is assigned an “ON” status, then all parts of the “Event” logic must be met before an action is taken. The “Event” field is whatever an installer selects from options contained in the firmware loaded onto the network switch 100. In this case, the event is related to an I.P. string. The complete event logic must complete before the method 1000 may be advanced to the action operation. In at least one example embodiment a network administrator may populate several fields of FIG. 8C to enable the method of FIG. 8B.

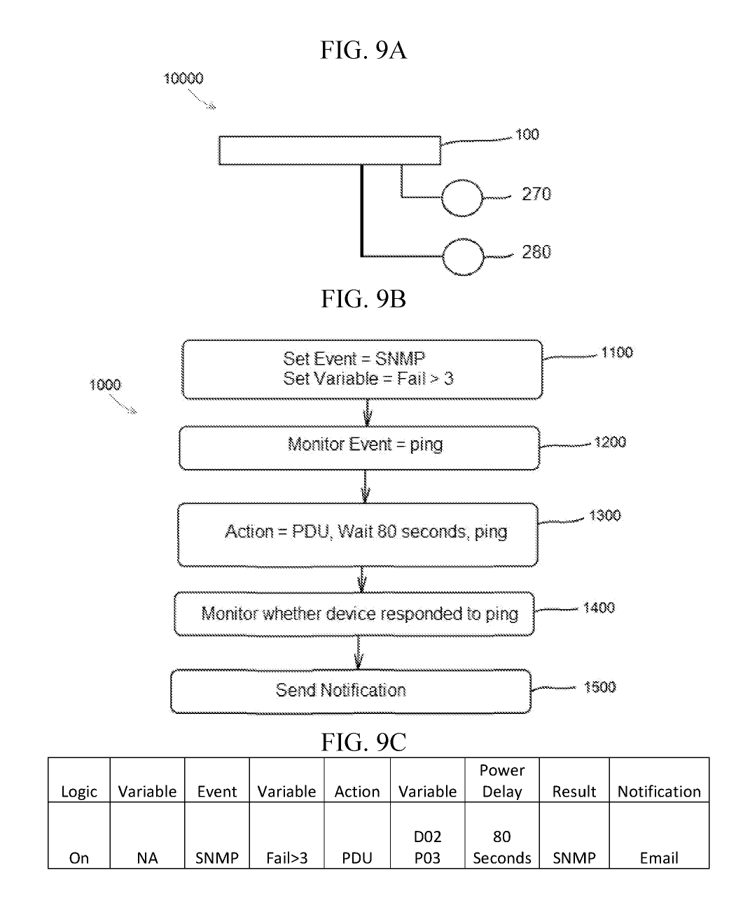

FIG. 9A is a view of a system 10000 using the network switch 100. In FIG. 4A, the system 10000 includes the network switch 100 with an ISP Router 270 and a power distribution unit (PDU) 280 attached thereto. It is known that ISP routers have a problem of “freezing” for no apparent reason. Conventional network switches have no way of dealing with this problem. However, the network switch 100 configured via the inventor's firmware can minimize, if not eliminate, the above problem. For example, a network administrator may configure the network switch 100, via inventor's firmware, to regularly ping the ISP Router 270 and monitor the response of the ping (step 1200). The network administrator may decide that if the ISP Router 270 fails to respond to a predetermined number of pings (for example, three consecutive pings), that the network switch 100 should undertake the action of powering down the power distribution unit 280 (for example, power cycle PDU Device ID 02 and outlet 003), wait a predetermined amount of time (for example, 80 seconds), re-ping the ISP Router 270 to see if the ISP Router 270 responds to the ping, and send all of this information to the network administrator (step 1500) via email or some other messaging system such as, but not limited to, i-messaging. This method is illustrated in FIG. 9B. It should be understood that some modifications fall within this illustrative example. For example, the method could require an internet location such as, but not limited to, 8.8.8.8, be pinged via the ISP Router 270 to confirm real live access to the internet. Forcing a response from the internet location would ensure the ISP Router 270 was properly functioning.

The message sent by the network switch 100 may provide the network administrator with valuable information. For example, if the ISP Router 270, after power cycling, started responding to various pings generated by the network switch 100, the network administrator may conclude the ISP Router 270 is functioning properly, however, if the ISP Router 270 failed to respond to the latest ping, the network administrator may conclude the ISP Router 270 requires maintenance. Furthermore, the software controlling the network switch 100 may correct the problem associated with the ISP Router 270 in the event the power cycling “unfroze” the ISP Router 270. As such, the duration for which the ISP Router 270 was “frozen” may be much shorter than the duration an ISP Router 270 may experience when connected to a conventional network switch since conventional network switches are generally not designed to periodically ping attached ISP Routers and power cycle them in the event they fail to respond to a ping.

FIG. 9C illustrates an example of how a network administrator could use the firmware to set up an automated sequence of commands which may repair a fault (for example, a “frozen” ISP Router) and notify the network administrator of the fault and the current state of the network or connected hardware. This may be done on a per port basis and have “and” and “or” logic options. As one skilled in the art would readily understand, FIG. 9C represents an interface having fields which may be populated by a network administrator. For example, the interface may have the following fields, “Logic,” “Variable,” “Event,” “Variable,” “Action,” “Variable,” “Power Delay,” “Result,” and “Notification.”

As was previously explained, when the “Logic” field is assigned an “ON” status the other logic blocks will be evaluated. If the “Logic” field was assigned an “OFF” status, the other blocks would not be evaluated. If the “Logic” field is assigned an “ON” status, then all parts of the “Event” logic must be met before an action is taken. The “Event” field is whatever an installer selects from options contained in the firmware loaded onto the network switch 100. The complete event logic must complete before the method may be advanced to the action operation. FIG. 9C shows how a user may define the above variables to enable the method of FIG. 9B to be carried out by the network switch 100.

The inventive concepts provided herein may be enabled in any number of ways and may be, at least partially, enabled using conventional products. For example, NMAP is a security scanner used to discover hosts and services on a computer network, thus creating a “map” of the network. NMAP accomplishes this by sending packets to the target hosts and then analyzing the responses. NMAP software provides a number of features for probing computer networks, including host discovery and service and operating system detection. These features are extensible by scripts that provide more advanced service detection, vulnerability detection, and other features. Nmap is also capable of adapting to network conditions including latency and congestion during a scan. Router, switches, and wifi controllers implementing NMap are usable in the network of example embodiments.

Wireshark is another third party product that may also enable various aspects of the invention. As one skilled in the art would acknowledge, Wireshark is an open-source packet analyzer often used for network troubleshooting, analysis, and software and communications protocol development. Wireshark is cross-platform, using the Qt widget toolkit in current releases to implement its user interface, and using pcap to capture packets. Wireshark may run on Linux, OS X, BSD, Solaris, some other Unix-like operating systems, and Microsoft Windows.

Wireshark allows a user to put network interface controllers that support “promiscuous mode” into that mode. This allows the user to see all traffic visible on that interface, not just traffic addressed to one of the interface's configured addresses and broadcast/multicast traffic. However, when capturing with a packet analyzer in promiscuous mode on a port on a network switch, not all traffic through the switch is necessarily sent to the port where the capture is done, so capturing in promiscuous mode is not necessarily sufficient to see all network traffic. Port mirroring or various network taps extend capture to any point on the network. Simple passive taps are extremely resistant to tampering. Router, switches, and wifi controllers implementing Wireshark are usable in the network of example embodiments.

Also, the inventor has contemplated the invention be applied under 802.15 standards. As such, the invention disclosed herein may be implemented in a wireless personal area network (WPAN). Thus, elements, such as network routers and wifi controllers satisfying the 802.15 standards are also considered to fall within the inventive concepts of this application and may be used with any of the previously disclosed embodiments.

The foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that which falls within the scope of the claims.

What is claimed is:

1. A method of controlling an electronic device, comprising:
defining an event and a variable on a computer readable medium which is usable by a controller to control the electronic device;
using the controller to automatically monitor the electronic device for the variable, perform an action when the variable occurs, and send a notification wherein the notification includes information about the action.

2. The method of claim 1, wherein the controller monitors a result of the action and the notification further includes information about the monitored result.

3. The method of claim 1, wherein the controller is a network switch.

4. The method of claim 1, wherein the controller further monitors a result of the action, wherein the notification further includes information about the monitored result.

5. The method of claim 1, wherein the event is one of SNMP, power, data, and an IP string.

6. The method of claim 1, wherein the variable is one of time, number of pings not responded to, power, and data rate.

7. The method of claim 1, wherein the action is one of powering down the electronic device, disabling a port, changing a Vlan, and mirroring data.

8. The method of claim 1, wherein the notification is an email.

9. The method of claim 1, wherein each of the notification includes information about the event and the variable.

10. An electronic controller configured to:
monitor an electronic device for a variable;
perform an action when the variable occurs; and
send a notification, the notification including information about the action, wherein the controller is configured to receive information about an event and the variable before monitoring the electronic device.

11. The controller of claim 10, wherein the controller is further configured to monitor the result of the action, wherein the notification further includes information about the monitored result.

12. The controller of claim 10, wherein the event is one of SNMP, power, data, and an IP string.

13. The controller of claim 10, wherein the variable is one of time, number of pings not responded to, power, and data rate.

14. The controller of claim 10, wherein the action is one of powering down the electronic device, disabling a port, changing a Vlan, and mirroring data.

15. The controller of claim 10, wherein the notification is an email.

16. The controller of claim 10, wherein the controller is a network switch.

17. A computer program product comprising a computer readable medium having a computer readable program code embodied in the medium configured to cause an electronic device to take an action when an event is detected, said computer readable program code comprising:
a first computer readable program code configured to generate an input screen for a user and allow the user to define the event and a variable on a computer readable medium which is usable by a controller to control the electronic device;
a second computer readable program code which enables the controller to automatically monitor the electronic device for the variable, perform an action when the variable occurs, and send a notification, wherein the notification includes information about the action.

18. The computer program product of claim 17, wherein the computer readable program code further includes computer code configured to allow the controller to monitor a result of the action and further allows the controller to include information about the monitored result in the notification.

19. The computer program product of claim 17, wherein the computer readable program code is configured to control a network switch.

20. The computer program product of claim 17, wherein the event is one of SNMP, power, data, and an IP string.
